(19) United States
(12) Patent Application Publication
(10) Pub. No.: US 2024/0391198 A1
(43) Pub. Date: Nov. 28, 2024

(54) MIDDLE DRUM ASSEMBLY OF BUILDING DRUM, BUILDING DRUM, AND METHOD FOR REPLACING MIDDLE DRUM BLOCK OF MIDDLE DRUM ASSEMBLY

(71) Applicants: MESNAC CO., LTD., QINGDAO, SHANDONG PROVINCE (CN); QINGDAO MESNAC MACHINERY & ELECTRIC ENGINEERING CO., LTD., QINGDAO, SHANDONG PROVINCE (CN)

(72) Inventors: XIAOSONG SUN, QINGDAO, SHANDONG PROVINCE (CN); YIHANG YU, QINGDAO, SHANDONG PROVINCE (CN); JIANLING SONG, QINGDAO, SHANDONG PROVINCE (CN)

(21) Appl. No.: 18/270,672

(22) PCT Filed: Dec. 29, 2021
(86) PCT No.: PCT/CN2021/142573

§ 371 Date: Jun. 30, 2023

(30) Foreign Application Priority Data
Dec. 31, 2020 (CN) 202011638978.2

(51) Int. Cl. B29D 30/26

(52) U.S. Cl. CPC B29D 30/26

(57) ABSTRACT

The present invention provides a middle drum assembly of a building drum, and a replacement method for a middle drum block of the middle drum assembly and a building drum. The middle drum assembly includes: a drum shoulder; a middle drum block having a mounting groove and a fixing hole; a first fastener movably disposed in the drum shoulder and capable of moving along the axial direction of the building drum, the first fastener having a step surface, the mounting groove being aligned with the first fastener when the middle drum block is abutting joint the drum shoulder along the radial direction of the building drum, and the middle drum block pressing the step surface and enabling a part of the first fastener to stretch into the mounting groove; a second fastener, a part of the second fastener passing through the drum shoulder; when a part of the first fastener stretches into the mounting groove, the fixing hole is aligned with the second fastener; the middle drum block is close to the drum shoulder along the axial direction of the building drum; and a part of the second fastener exposed from the drum shoulder stretches into the fixing hole. The present invention solves the problem in the prior art that a tooth block replacement of the drum shoulder consumes time and effort.

### CROSS-REFERENCE TO RELATED APPLICATION

This application claims priority to Chinese Patent Application No. 202011638978.2, filed with the State Intellectual Property Office of the P.R. China on 31 Dec. 2020 and entitled “Middle Drum Assembly of Building Drum, and Replacement Method for Middle Drum Block of Middle Drum Assembly and Building Drum”.

### TECHNICAL FIELD

The present invention relates to the technical field of tire processing, and in particular to a middle drum assembly of a building drum, and a replacement method for a middle drum block of the middle drum assembly and the building drum.

### BACKGROUND TECHNOLOGY

The length of the toothed blocks at the drum shoulder of the building drum needs to be changed according to different tire specifications. Conventionally, the toothed blocks are connected to the toothed block connecting seat via screws. In this way, when the toothed blocks are changed, the screws need to be removed, which takes a lot of time and affects efficiency.

### SUMMARY OF THE INVENTION

The main purpose of the present invention is to provide a middle drum assembly of a building drum, and a replacement method for a middle drum block of the middle drum assembly and the building drum, so as to solve the problem in the prior art that the replacement of a toothed block at a drum shoulder consumes time and effort.

In order to achieve the described object, according to an optional embodiment of the present invention, a middle drum assembly of a building drum is provided, including: a drum shoulder; a middle drum block having a mounting groove and a fixing hole; a first fastener movably disposed in the drum shoulder and capable of moving along the axial direction of the building drum, the first fastener has a step surface, and the middle drum block is abutting joint the drum shoulder in the radial direction of the building drum, the mounting groove is aligned with the first fastener, the middle drum block presses the step surface and a part of the first fastener stretches into the mounting groove; a second fastener, a part of the second fastener passing through the drum shoulder, wherein after the part of the first fastener stretches into the mounting groove, the fixing hole is aligned with the second fastener, the middle drum block is close to the drum shoulder along the axial direction of the building drum, and a part of the second fastener exposed out of the drum shoulder stretches into the fixing hole.

In an optional embodiment, the middle drum block is arc-shaped, and the mounting groove is in communication with both an inner side wall of the arc shape and an end surface of the arc shape.

In an optional embodiment, the first fastener includes a large diameter section and a small diameter section which are sequentially connected, the step surface is formed between the large diameter section and the small diameter section, the small diameter section stretches into the drum shoulder, and the large diameter section is able to stretch into the mounting groove.

In an optional embodiment, the mounting groove includes a diameter-expanding section and a diameter-reducing section that are sequentially communicated with each other, the diameter-reducing section is closer to an end surface of the drum shoulder than the diameter-expanding section, the large diameter section stretches into the diameter-expanding section, the small diameter section stretches into the diameter-reducing section, and the step surface abuts against an end surface of the diameter-reducing section that faces the diameter-expanding section.

In an optional embodiment, an outer edge of the mounting groove is provided with an inclined surface, along a direction in which the middle drum block is abutting joint the drum shoulder in the radial direction of the building drum, the inclined surface is inclined in a direction away from the drum shoulder, when the middle drum block is abutting joint the drum shoulder in the radial direction of the building drum, the inclined surface presses the step surface, and enabling the first fastener to move in a direction of protruding from the drum shoulder, and to stretch into the mounting groove.

In an optional embodiment, the middle drum assembly further including an elastic member, wherein two ends of the elastic member are respectively abutted against the drum shoulder and the first fastener, and provide with an elastic force for the first fastener moving in a direction stretching into the drum shoulder.

In an optional embodiment, the middle drum block includes: a tooth portion located on an outer side of the middle drum block; a connecting portion located on an inner side surface of an end portion of the tooth portion, wherein the mounting groove and the fixing hole are both provided on an end surface of the connecting portion.

In an optional embodiment, a plurality of fixing holes and a plurality of second fasteners are provided, and both sides of the mounting groove are respectively arranged on at least one fixing hole of the plurality of fixing holes.

In an optional embodiment, the mounting groove is a U-shaped groove, the first fastener is a screw having a screw head, and the second fastener is a pin.

According to an optional embodiment of the present invention, a building drum is provided, which includes the described middle drum assembly.

According to an optional embodiment of the present invention, a replacement method for a middle drum block of a middle drum assembly is provided, the middle drum assembly includes a drum shoulder, a middle drum block, and a first fastener and a second fastener which pass through the drum shoulder, the middle drum block is provided with a mounting groove and a fixing hole, the replacement method for the middle drum block includes: the middle drum block is close to one side of a drum shoulder in the radial direction of the middle drum assembly, and forming a gap with an end surface of the drum shoulder, and then the middle drum block continuing to move towards a centre of the middle drum assembly, during a movement process, the middle drum block presses a step surface of the first fastener, such that one end of the first fastener is away from the drum shoulder and stretches into the mounting groove, when the middle drum block moves until the fixing hole is aligned with the second fastener, the middle drum block is close to the end surface of the drum shoulder along the axial direction of the middle drum assembly, a part of the first fastener retracts into the drum shoulder, and the second fastener stretches into the fixing hole.

In an optional embodiment, the first fastener includes a large diameter section and a small diameter section which are sequentially connected; the step surface is formed between the large diameter section and the small diameter section; when the middle drum block presses the step surface, the first fastener moves in a direction of protruding from the drum shoulder; and the large diameter section stretches into the mounting groove.

In an optional embodiment, an outer edge of the mounting groove is provided with an inclined surface, and when the middle drum block continues to move towards the center of the middle drum assembly, the inclined surface presses the step surface.

In an optional embodiment, the middle drum assembly further includes an elastic member, when the middle drum block presses the step surface, the first fastener compresses the elastic member, the length of the elastic member is shortened, and when the middle drum block is close to the end surface of the drum shoulder in the axial direction of the middle drum assembly, the first fastener releases the elastic member, and the length of the elastic member is lengthen.

By applying the technical solution of the present invention, the mounting groove and the fixing hole are provided on the middle drum block, and the first fastener and the second fastener are respectively provided with the mounting groove and the fixing hole by matching manner, wherein the first fastener and the second fastener penetrate the drum shoulder in advance. When the middle drum block needs to be mounted, the middle drum block is pressed downwards along one side of the radial direction of the building drum close to the drum shoulder. During this process, the middle drum block compresses the step surface of the first fastener, causing the first fastener to move in a direction to extend beyond the drum shoulder. One end of the first fastener is able to stretch into the mounting groove, and a distance is formed between the end surface of the middle drum block and the end surface of the drum shoulder, the distance is not less than the distance that the second fastener is exposed to the drum shoulder, so that the middle drum block is able to avoid the movement of the second fastener, when the middle drum block moves radially into place, the fixing hole is aligned with the second fastener, and at this moment, the middle drum block is axially pushed, so that the middle drum block moves in the direction of approaching the drum shoulder, and the first fastener moves in the direction of retracting the drum shoulder, at the same time, the second fastener stretches into the fixing hole, so that the radial movement of the middle drum block is locked by the second fastener, In addition, the axial movement needs an external force to pull the middle drum block, so that the middle drum block is mounted on the drum shoulder. When the middle drum block needs to be disassembled, the middle drum block is axially pulled by an external force, so that the second fastener is separated from the fixing hole, and then the drum block is radially pulled, so that the first fastener is separated from the mounting groove, and thus the middle drum block is disassembled and replaced. The above-mentioned arrangement method enables the dismounting and mounting of the middle drum block to be carried out quickly without the need of a dismounting screw, thus greatly improving the replacement efficiency; in addition, the dismounting and mounting process only needs to be carried out by one-step pressing and one-step pushing and one-step pulling and one-step lifting, so that the dismounting and mounting are convenient and time-saving and labour-saving.

### BRIEF DESCRIPTION OF THE DRAWINGS

The accompanying drawings, which form a part of the present invention, are configured for providing a further understanding of the present invention. The schematic embodiments and illustrations of the present invention are configured for explaining the present invention, and do not form improper limits to the present invention. In the drawings:

FIG. 1 shows a sectional view of a middle drum assembly at a mounting groove in the present invention;

FIG. 2 shows a cross-sectional view of the middle drum assembly of FIG. 1 at a fixing hole;

FIG. 3 shows a schematic view of a middle drum block of the middle drum assembly in FIG. 1.

The figures include the following reference signs:
10: Drum shoulder; 20: middle drum block; 21: mounting groove; 22: fixing hole; 23: inclined plane; 24: Tooth portion; 25: connecting portion; 30: first fastener; 40: second fastener; 50: elastic member.

### DETAILED DESCRIPTION OF THE EMBODIMENTS

It is important to note that the embodiments of the present disclosure and the characteristics in the embodiments may be combined under the condition of no conflicts. The present disclosure will be described below with reference to the drawings and embodiments in detail.

In order to solve the problem in the prior art that changing a toothed block at a drum shoulder consumes time and effort, the present invention provides a middle drum assembly of a building drum, and a replacement method for a middle drum block of the middle drum assembly and the building drum. Wherein, the building drum has a middle drum assembly as described below.

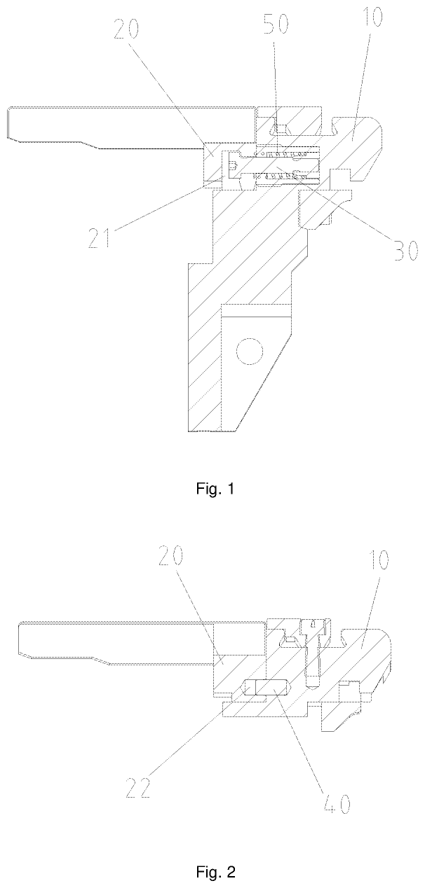

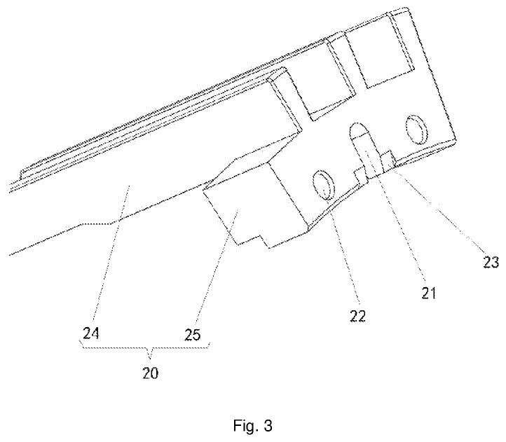

A middle drum assembly of a building drum as shown in FIGS. 1-3, including a drum shoulder 10, a middle drum block 20, a first fastener 30 and a second fastener 40, wherein the middle drum block 20 is provided with an mounting groove 21 and a fixing hole 22; the first fastener 30 is movably disposed in the drum shoulder 10 and moved along the axial direction of the building drum; the first fastener 30 has a step surface; when the middle drum block 20 abuts against the drum shoulder 10 along the radial direction of the building drum, the mounting groove 21 is aligned with the first fastener 30; the middle drum block 20 compresses the step surface and enables a part of the first fastener 30 to stretch into the mounting groove 21; a part of the second fastener 40 passes through the drum shoulder 10. After the part of the first fastener 30 stretches into the mounting groove 21, the fixing hole 22 is aligned with the second fastener 40, the middle drum block 20 is close to the drum shoulder 10 along the axial direction of the building drum, and a part of the second fastener 40 exposed outside the drum shoulder 10 stretches into the fixing hole 22.

In the present embodiment, the mounting groove 21 and the fixing hole 22 are provided on the middle drum block 20, and the first fastening member 30 and the second fastening member 40 are provided in matching with the mounting groove 21 and the fixing hole 22, wherein the first fastening member 30 and the second fastening member 40 are pre-penetrated on the drum shoulder 10. When it is required to mount the middle drum block 20, the middle drum block 20 is firstly arranged along the radial direction of the building drum on the side close to the drum shoulder 10, pressing down the middle drum block 20, in which process, the middle drum block 20 presses the step surface of the first fastener 30, so that the first fastener 30 moves in a direction of protruding from the drum shoulder 10, One end of the first fastener 30 is able to stretch into the mounting groove 21, and a distance is formed between an end surface of the middle drum block 20 and an end surface of the drum shoulder 10, the distance is not less than the distance that the second fastener 40 is exposed to the drum shoulder 10, so that the middle drum block 20 is able to avoid the movement of the second fastener 40. When the middle drum block 20 is radially moved into place, the fixing hole 22 is aligned with the second fastener 40, and at this time, the middle drum block 20 is axially pushed, so that the middle drum block 20 moves in a direction of approaching the drum shoulder 10, and the first fastener 30 moves in a direction of retracting the drum shoulder 10, at the same time, the second fastener 40 stretches into the fixing hole 22, such that the radial movement of the middle drum block 20 is locked by the second fastener 40. In addition, the axial movement needs an external force to pull the middle drum block 20, so that the middle drum block 20 is mounted on the drum shoulder 10. When the middle drum block 20 needs to be disassembled, the middle drum block 20 is axially pulled by an external force, so that the second fastener 40 is separated from the fixing hole 22, and then the middle drum block 20 is radially pulled, so that the first fastener 30 is separated from the mounting groove 21, and then the middle drum block 20 is disassembled and replaced. The above-mentioned arrangement method enables the dismounting and mounting of the middle drum block 20 without the need of a dismounting screw, so that the dismounting and mounting are performed quickly, thereby greatly improving the replacement efficiency. In addition, the dismounting and mounting process only needs to be performed by one-step pressing and one-step pushing and one-step pulling and one-step lifting, so that the dismounting and mounting are convenient and time-saving and labour-saving.

The axial direction and the radial direction mentioned in this embodiment refer to both the axial direction and the radial direction of the building drum, and more specifically, the axial direction and the radial direction of the main shaft of the building drum.

In the present embodiment, the middle drum block 20 is arc-shaped, the arc-shape cooperates with other structures of the building drum, such as a backing plate and a sliding block; the mounting groove 21 is in communication with both the arc-shaped inner side wall and the arc-shaped end surface; the first fastener 30 stretches into the mounting groove 21 via the arc-shaped inner side wall, and the end surface is in communication for avoiding the first fastener 30, so as to ensure that the first fastener 30 stretches into the mounting groove 21.

Preferably, the mounting groove 21 of the present embodiment is U-shaped, and the opening side of the U-shape faces the inner side of the arc-shaped middle drum block 20.

In this embodiment, the length direction of the mounting groove 21 and the fixing hole 22, and the axial direction of the first fastening member 30 and the axial direction of the second fastening member 40 are all along the axial direction of the building drum, and the sliding direction of the first fastening member 30 is also the axial direction of the building drum.

In the present embodiment, the first fastener 30 includes a large diameter section and a small diameter section which are connected in sequence, wherein a step surface is formed between the large diameter section and the small diameter section, the small diameter section stretches into the drum shoulder 10, and the large diameter section is able to stretch into the mounting groove 21. The first fastener 30 of this embodiment uses a screw, and a screw head with a larger diameter at one end of the screw is a large diameter section, the other part of the screw is a small diameter section, the small diameter section passes through the drum shoulder 10, and the large diameter section is exposed to the drum shoulder 10, such that when the drum block 20 is pressed downwards radially, due to the large size of the large diameter section, the outer edge of the mounting groove 21 will press the step surface formed between the large diameter section and the small diameter section. Thus, the first fastener 30 is pulled out of the drum shoulder 10 for a distance, and the effect of avoiding the second fastener 40 and the drum block 20 in subsequent fastening is achieved.

Corresponding to the structure of the first fastener 30, the mounting groove 21 includes a diameter-expanding section and a diameter-reducing section which are sequentially communicated, furthermore, the diameter-reducing section is closer to the end surface of the drum shoulder 10 than the diameter-expanding section, and when the drum block 20 is pressed down, the large diameter section stretches into the diameter-expanding section, the small diameter section stretches into the diameter-reducing section, such that the step surface of the first fastener 30 is able to abut against the end surface of the diameter-reducing section facing the diameter-expanding section, realizing a stop fit between the first fastener 30 and the middle drum block 20, and when the middle drum block 20 is pulled in a direction away from the drum shoulder 10, the end surface of the diameter-reducing segment is able to drive the first fastener 30 to move by pressing the step surface.

In the present embodiment, the outer edge of the mounting groove 21, i.e., the corner of the mounting groove 21 on the inner side of the end surface of the middle drum block 20, is provided with a inclined surface 23, furthermore, in the direction in which the drum block 20 abuts against the drum shoulder 10 in the radial direction of the building drum, the inclined surface 23 is inclined away from the drum shoulder 10. In this way, when the middle drum block 20 is pressed down, the middle drum block 20 abuts against the drum shoulder 10 in the radial direction of the building drum, the inclined surface 23 squeezes the edge of the step surface, thereby moving the first fastener 30 in a direction to protrude from the drum shoulder 10. Thus, when pulled out of the drum shoulder 10, the larger diameter section of the first fastener 30 is able to stretch into the mounting groove 21. By means of the arrangement of the inclined surface 23, the first fastener 30 is smoothly squeezed and pulled out of the first fastener 30, thereby ensuring the fluency of a pressing action.

In this embodiment, the middle drum assembly further includes an elastic member 50, the elastic member 50 is a spring and is sleeved on the first fastener 30, two ends of the elastic member 50 respectively abut against the drum shoulder 10 and the first fastener 30, and provide an elastic force for the first fastener 30 to move in a direction stretching into the drum shoulder 10. In this way, on the one hand, when the middle drum block 20 is assembled and disassembled, the stop surface keeps abutting against the middle drum block 20 all the time, and when the middle drum block 20 moves axially, the stop surface keeps moving synchronously with the first fastener 30 all the time, on the other hand, after the installation is completed, the elastic member 50 pulls the middle drum block 20 close to the drum shoulder 10 via the first fastener 30, so that the middle drum block 20 is always tightly fitted with the drum shoulder 10, and the middle drum block 20 is always in a position close to the drum shoulder 10 when no external force is applied or no external force exceeding a certain magnitude is applied. The second fastening member 40 always stretches into the fixing hole 22 to ensure the stability of the middle drum block 20 after the middle drum block 20 is installed. It should be noted that the elastic force of the spring needs to be greater than the force of the drum block 20 shaking axially when the building drum is in normal use, so that the stability of the drum block 20 is ensured when the building drum is in normal operation, so that the drum block 20 is dismounted only when the operator disassembles the drum block 20. Certainly, in addition to the elastic member 50, the foregoing effect may also be implemented in another manner, for example, the first fastener 30 is replaced with an elastic unit, and the foregoing effect is implemented by using the elasticity of the first fastener 30; or in other ways.

the middle drum block 20 in the present embodiment is a toothed block, which includes a tooth portion 24 and a connecting portion 25, in which the tooth portion 24 is located on an outer side face of the middle drum block 20 and is configured for tire processing; the connecting portion 25 is located on an inner side surface of an end portion of the tooth portion 24 and is configured to cooperate with components such as a drum shoulder 10, and the mounting groove 21 and the fixing hole 22 are both provided on an end surface of the connecting portion 25.

In the present embodiment, one mounting groove 21 and one first fastener 30 are provided, the two cooperate with each other, and there are a plurality of fixing holes 22 and a plurality of second fasteners 40. In the present embodiment, two fixing holes 22 are provided, and at least one fixing hole 22 is provided on both sides of the mounting groove 21, so that the middle drum block 20 is subjected to a force balance, and the stability of the middle drum block 20 during normal operation of the building drum is ensured. In this embodiment, the fixing hole 22 is a blind hole, and the second fastening member 40 is a pin with an equal diameter. Certainly, the number of the components and the specific application may be changed as required.

The present embodiment further provides a replacement method for a middle drum block of a middle drum assembly. The middle drum assembly is the described middle drum assembly, including a drum shoulder 10, a middle drum block 20, and a first fastener 30 and a second fastener 40 which pass through the drum shoulder 10, the middle drum block 20 has a mounting groove 21 and a fixing hole 22. The replacement method for the middle drum block 20 includes: when the middle drum block 20 is mounted, the middle drum block 20 is located on one side, close to the drum shoulder 10, in the radial direction of the middle drum assembly, and forms a gap with the end surface of the drum shoulder 10, then the middle drum block 20 continues to move towards the centre of the middle drum assembly, and during the movement, the middle drum block 20 compresses the step surface of the first fastener 30, so that one end of the first fastener 30 is away from the drum shoulder 10 and stretches into the mounting groove 21, and after the drum block 20 moves to the fixing hole 22 and is aligned with the second fastener 40, the middle drum block 20 is close to the end surface of the drum shoulder 10 in the axial direction of the middle drum assembly, and a part of the first fastener 30 retracts into the drum shoulder 10, the second fastening member 40 stretches into the fixing hole 22. When it is required to remove the middle drum block 20, the described process is reversely operated.

In the present embodiment, since the first fastening member 30 includes a large diameter section and a small diameter section which are sequentially connected, and a step surface is formed between the large diameter section and the small diameter section, when the middle drum block 20 presses the step surface, the first fastening member 30 moves in a direction of protruding from the drum shoulder 10 under the pressing of the middle drum block 20, and the large diameter section stretches into the mounting groove 21.

In the present embodiment, the outer edge of the mounting groove 21 is provided with a inclined surface 23, and when the middle drum block 20 continues to move towards the center of the middle drum assembly, the inclined surface 23 presses the step surface.

In the present embodiment, the middle drum assembly further includes an elastic member 50, when the middle drum block 20 presses the step surface, the first fastener 30 compresses the elastic member 50, the length of the elastic member 50 becomes shorter, and when the middle drum block 20 is close to the end surface of the drum shoulder 10 in the axial direction of the middle drum assembly, the first fastener 30 releases the elastic member 50, and the length of the elastic member 50 becomes longer. The effect of limiting the axial movement of the middle bump 20 is achieved by the elastic member 50.

It should be noted that, a plurality in the foregoing embodiment refers to at least two.

From the above description, it is seen that the above embodiments of the present invention achieve the following technical effects:
1. the problem in the prior art that the replacement of a toothed block of a drum shoulder consumes time and effort is solved;
2. the dismounting and mounting of the middle drum block do not require a dismounting screw, and is rapidly dismounted and mounted, greatly improving the replacement efficiency;
3. The disassembling and assembling process only needs to be one-step pressed and one-step pushed and one-step pulled and one-step lifted, which is convenient for disassembling and assembling and saves time and effort.

Apparently, the embodiments described above are merely a part rather than all of the embodiments of the present invention. All other embodiments obtained by a person of ordinary skill in the art based on the embodiments of the present invention without creative efforts shall belong to the scope of protection of the present invention.

The foregoing descriptions are merely exemplary embodiments of the present invention, but are not intended to limit the present invention. For those skilled in the art, the present invention may have various modifications and variations. Any modifications, equivalent replacements, improvements and the like made within the spirit and principle of the present invention shall belong to the scope of protection of the present invention.

1. A middle drum assembly of a building drum, comprising:
a drum shoulder (10);
a middle drum block (20) having a mounting groove (21) and a fixing hole (22);
a first fastener (30) movably disposed in the drum shoulder (10) and capable of moving along the axial direction of the building drum, the first fastener (30) has a step surface, and the middle drum block (20) is abutting joint the drum shoulder (10) in the radial direction of the building drum, the mounting groove (21) is aligned with the first fastener (30), the middle drum block (20) presses the step surface and a part of the first fastener (30) stretches into the mounting groove (21);
a second fastener (40), a part of the second fastener (40) passing through the drum shoulder (10), wherein after the part of the first fastener (30) stretches into the mounting groove (21), the fixing hole (22) is aligned with the second fastener (40), the middle drum block (20) is close to the drum shoulder (10) along the axial direction of the building drum, and a part of the second fastener (40) exposed out of the drum shoulder (10) stretches into the fixing hole (22).

2. The middle drum assembly according to claim 1, wherein the middle drum block (20) is arc-shaped, and the mounting groove (21) is in communication with both an inner side wall of the arc shape and an end surface of the arc shape.

3. The middle drum assembly according to claim 1, wherein the first fastener (30) comprises a large diameter section and a small diameter section which are sequentially connected, the step surface is formed between the large diameter section and the small diameter section, the small diameter section stretches into the drum shoulder (10), and the large diameter section is able to stretch into the mounting groove (21).

4. The middle drum assembly according to claim 3, wherein the mounting groove (21) comprises a diameter-expanding section and a diameter-reducing section that are sequentially communicated with each other, the diameter-reducing section is closer to an end surface of the drum shoulder (10) than the diameter-expanding section, the large diameter section stretches into the diameter-expanding section, the small diameter section stretches into the diameter-reducing section, and the step surface abuts against an end surface of the diameter-reducing section that faces the diameter-expanding section.

5. The middle drum assembly according to claim 1, wherein an outer edge of the mounting groove (21) is provided with an inclined surface (23), along a direction in which the middle drum block (20) is abutting joint the drum shoulder (10) in the radial direction of the building drum, the inclined surface (23) is inclined in a direction away from the drum shoulder (10), when the middle drum block (20) is abutting joint the drum shoulder (10) in the radial direction of the building drum, the inclined surface (23) presses the step surface, and enabling the first fastener (30) to move in a direction of protruding from the drum shoulder (10), and to stretch into the mounting groove (21).

6. The middle drum assembly according to claim 1, wherein the middle drum assembly further comprising an elastic member (50), wherein two ends of the elastic member (50) are respectively abutted against the drum shoulder (10) and the first fastener (30), and provide with an elastic force for the first fastener (30) moving in a direction stretching into the drum shoulder (10).

7. The middle drum assembly according to claim 1, wherein the middle drum block (20) comprises:
a tooth portion (24) located on an outer side of the middle drum block (20);
a connecting portion (25) located on an inner side surface of an end portion of the tooth portion (24), wherein the mounting groove (21) and the fixing hole (22) are both provided on an end surface of the connecting portion (25).

8. The middle drum assembly according to claim 1, wherein a plurality of fixing holes (22) and a plurality of second fasteners (40) are provided, and both sides of the mounting groove (21) are respectively arranged on at least one fixing hole (22) of the plurality of fixing holes (22).

9. The middle drum assembly according to claim 1, wherein the mounting groove (21) is a U-shaped groove, the first fastener (30) is a screw having a screw head, and the second fastener (40) is a pin.

10. A building drum, comprising the middle drum assembly in claim 1.

11. A replacement method for a middle drum block of a middle drum assembly, wherein the middle drum assembly comprises a drum shoulder (10), a middle drum block (20), and a first fastener (30) and a second fastener (40) which pass through the drum shoulder (10), the middle drum block (20) is provided with a mounting groove (21) and a fixing hole (22), the replacement method for the middle drum block (20) comprises: the middle drum block (20) is close to one side of a drum shoulder (10) in the radial direction of the middle drum assembly, and forming a gap with an end surface of the drum shoulder (10), and then the middle drum block (20) continuing to move towards a centre of the middle drum assembly, during a movement process, the middle drum block (20) presses a step surface of the first fastener (30), such that one end of the first fastener (30) is away from the drum shoulder (10) and stretches into the mounting groove (21), when the middle drum block (20) moves until the fixing hole (22) is aligned with the second fastener (40), the middle drum block (20) is close to the end surface of the drum shoulder (10) along the axial direction of the middle drum assembly, a part of the first fastener (30) retracts into the drum shoulder (10), and the second fastener (40) stretches into the fixing hole (22).

12. The replacement method for the middle drum block according to claim 11, wherein the first fastener (30) comprises a large diameter section and a small diameter section which are sequentially connected; the step surface is formed between the large diameter section and the small diameter section; when the middle drum block (20) presses the step surface, the first fastener (30) moves in a direction of protruding from the drum shoulder (10); and the large diameter section stretches into the mounting groove (21).

13. The replacement method for the middle drum block according to claim 11, wherein an outer edge of the mounting groove (21) is provided with an inclined surface (23), and when the middle drum block (20) continues to move towards the center of the middle drum assembly, the inclined surface (23) presses the step surface.

14. The replacement method for the middle drum block according to claim 11, wherein the middle drum assembly further comprises an elastic member (50), when the middle drum block (20) presses the step surface, the first fastener (30) compresses the elastic member (50), the length of the elastic member (50) is shortened, and when the middle drum block (20) is close to the end surface of the drum shoulder (10) in the axial direction of the middle drum assembly, the first fastener (30) releases the elastic member (50), and the length of the elastic member (50) is lengthen.
